(19) United States
(12) Patent Application Publication
(10) Pub. No.: US 2026/0011522 A1
(43) Pub. Date: Jan. 8, 2026

(54) GRIDDED CATHODE APPARATUSES AND X-RAY SYSTEMS

(71) Applicant: Varex Imaging Corporation, Salt Lake City, UT (US)

(72) Inventors: Kendra Jean Davis, Salt Lake City, UT (US); Lincoln Curtis Jolley, Stansbury Park, UT (US); Evgeny Galyaev, Phoenix, AZ (US); Erinn Scott Sorge, Murray, UT (US); Natalie McDermott, South Jordan, UT (US); Tyson Baker, Salt Lake City, UT (US)

(73) Assignee: Varex Imaging Corporation, Salt Lake City, UT (US)

(21) Appl. No.: 18/763,992

(22) Filed: Jul. 3, 2024

(51) Int. Cl. H01J 35/06

(52) U.S. Cl. CPC H01J 35/064; H01J 2235/06

(57) ABSTRACT

Embodiments include an apparatus, comprising: a conductive base; an insulating substrate; an electron emitter disposed on the insulating substrate; a grid disposed adjacent to the electron emitter, the grid including a first conductive side and a second conductive side separate from the first conductive side; a plurality of posts; wherein: the first conductive side is attached to the insulating substrate through a first group of the posts; the second conductive side is attached to the insulating substrate through a second group of the posts; and the conductive base is attached to the insulating substrate through a third group of the posts.

Some X-ray systems may include gridded cathode heads. Manufacturing of gridded cathode heads that require insulation between the grid components and the base material may have lower yields as compared with non-gridded cathode heads. Movement of the grid components relative to the base material during manufacturing may cause a failure.

### BRIEF DESCRIPTION OF DRAWINGS

FIGS. 1A-1B are block diagrams of an apparatus with an electron emitter according to some embodiments.

FIG. 2 is a block diagram of an apparatus with a field electron emitter according to some embodiments.

FIG. 3 is a block diagram of an apparatus with multiple electron emitters according to some embodiments.

FIG. 4 is a block diagram of an apparatus with multiple electron emitters and non-coplanar grids according to some embodiments.

FIG. 5 is a block diagram of an apparatus with multiple electron emitters according to some other embodiments.

FIG. 6 is a block diagram of an x-ray source with an electron emitter according to some embodiments.

FIG. 7 is a flowchart of a technique of forming an apparatus with an electron emitter according to some embodiments.

FIG. 8 is a flowchart of a technique of attaching a grid to an apparatus with an electron emitter according to some embodiments.

FIG. 9 is a block diagram of an x-ray imaging system according to some embodiments.

### DETAILED DESCRIPTION

Some embodiments include gridded cathode apparatuses, x-ray sources with gridded cathode apparatuses, and x-ray systems including the same. As will be described in further detail below, embodiments include apparatuses with electron emitters with various structures that may improve the yield. Such apparatuses may be installed in a cathode apparatus, x-ray source, x-ray system, or the like.

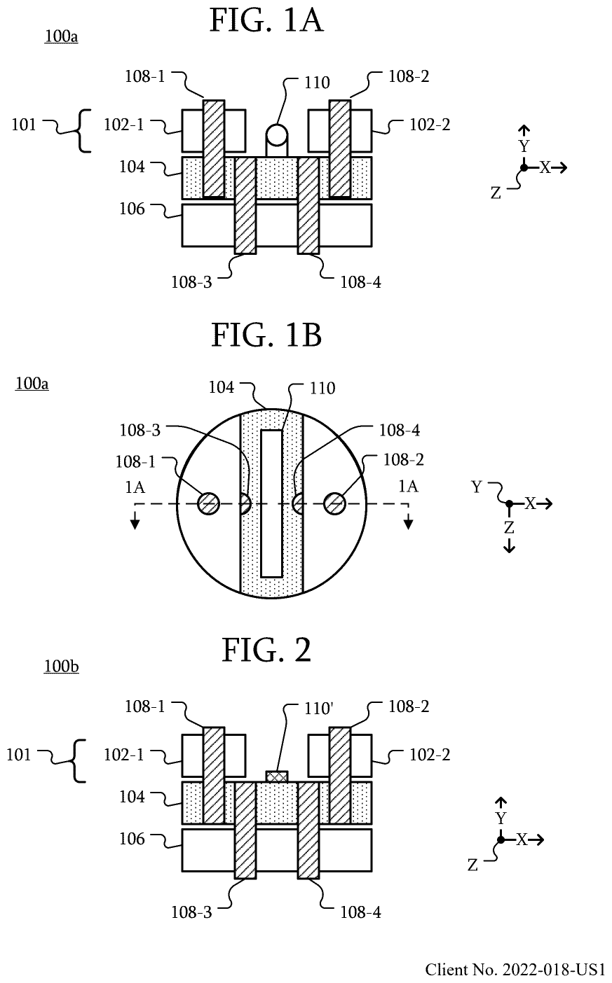

FIGS. 1A-1B are block diagrams of an apparatus with an electron emitter according to some embodiments. Referring to FIGS. 1A-1B, FIG. 1A is a cross-sectional view in plane 1A of FIG. 1B. In some embodiments, an apparatus 100a includes a conductive base 106, an insulating substrate 104, an electron emitter 110, multiple posts 108, and a grid 101.

The conductive base 106 may include a conductive material such as metal, steel, nickel, conductive alloys such as Kovar, or other conductive vacuum compatible materials. The insulating substrate 104 may include an insulating material such as ceramic such as alumina oxide ceramic, glass, or other vacuum compatible insulators.

The electron emitter 110 is disposed on the insulating substrate 104. The electron emitter 110 may be disposed on the insulating substrate 104 through isolating eyelets (not illustrated) or the like to create an electrical connection to terminals of the electron emitter 110 through the insulating substrate 104, the conductive base 106, or the like. In some embodiments, the eyelets pass through the insulating substrate 104 and are not directly attached to the insulating substrate 104. The eyelets may be isolated from the conductive base 106 by insulators separate from the insulating substrate; however, in other embodiments, one or more of the eyelets may be electrically connected to the conductive base 106. The electron emitter 110 is a device configured to generate electrons. For example, the electron emitter 110 may include a filament emitter, a thermionic emitter, a field emission emitter, or the like.

The grid 101 is disposed adjacent to the electron emitter 110. The grid 101 may include a conductive material such as metal, steel, nickel, conductive alloys such as Kovar, or other conductive vacuum compatible materials. The material of the grid 101 may be the same or different from the material of the conductive base 106.

One or more voltages may be applied to the grid 101, sub-parts of the grid 101, or the like. The applied voltage may, in combination with the electrical potential of the conductive base 106 may be configured to focus, steer, shape, or otherwise modify an electron beam generated from the electron emitter 110. In this example, the grid 101 includes a first conductive side 102-1 and a second conductive side 102-2 separate from the first conductive side 102-1. In some embodiments, the conductive sides 102-1 and 102-2 may be structurally separate, but electrically connected through another structure (not illustrated). In other embodiments, the conductive sides 102-1 and 102-2 may be electrically isolated from each other.

The posts 108 are attached to various other structures of the apparatus 100a. The posts 108 are attached to the corresponding structures along the length of the posts 108. The number of posts 108 attached to various structures of the apparatus 100a are used as examples. Other embodiments may include a different number of posts 108. The location of the attachment of the posts to the various structures are also an example. In other embodiments, the posts 108 may be attached to the various structures in different locations. For example, each of the conductive sides 102-1 and 102-2 may be attached with multiple posts 108 in a line along the Y direction.

The first conductive side 102-1 is attached to the insulating substrate 104 through a first group of the posts 108. Here, the first group includes a single post 108-1; however, in other embodiments, multiple posts 108 may be part of the first group that attaches the first conductive side 102-1 to the insulating substrate 104. Each of the first conductive side 102-1 and the insulating substrate 104 includes an opening in which the post 108-1 is disposed. The post 108-1 is attached to the first conductive side 102-1 and the insulating substrate 104.

The post 108-1 may be attached to the first conductive side 102-1 and the insulating substrate 104 by a variety of techniques. For example, the post 108-1 may be attached by brazing, welding, or the like. The structures may have additional components related to the attachment, such as metallization on the insulating substrate 104 that facilitates brazing to the post 108-1.

The first conductive side 102-1 and the insulating substrate 104 may not be attached directly together. Rather, the first conductive side 102-1 and the insulating substrate 104 may be attached through the post 108-1. Gaps are illustrated between the conductive sides 102-1, 102-2, insulating substrate 104, and the conductive base 106. The gaps are illustrated to show that the conductive sides 102-1, 102-2, insulating substrate 104, and the conductive base 106 are not attached directly to each other. Rather, the attachment between the components is through the posts 108. The components may contact each other, but may not be directly attached. As a result, a difference in thermal expansion between the conductive side 102-1 and the insulating substrate 104 may not result in the failure of an attachment location as the conductive side 102-1 and the insulating substrate 104 are not directly attached to each other.

In some embodiments, the post 108-1 only attaches to the first conductive side 102-1 and the insulating substrate 104. The post 108-1 may be separate from other structures. That is, the post 108-1 may not be attached to the conductive base 106. The post 108-1 may not contact the conductive base 106.

The second conductive side 108-2 is attached to the insulating substrate 104 through a second group of the posts 108. Here, the second group of the posts 108 includes a single post 108-2. The relationship, attachment, and the like of the post 108-2 to the second conductive side 108-2 and the insulating substrate 104 may be the same or similar to the attachments involving the post 108-1 described above.

The conductive base 106 is attached to the insulating substrate 104 through a third group of the posts 108. Here, the third group includes posts 108-3 and 108-4. However, in other embodiments, the third group may include one or more posts 108. The posts 108-3 and 108-4 may be attached to the conductive base 106 and the insulating substrate 104 in a manner the same or similar to the attachments involving the post 108-1 described above.

The material of the posts 108 may be selected based on materials of the conducive base 106, the insulating substrate 104, and the grid 101. For example, the material of the posts 108 may be selected to have a coefficient of thermal expansion that is between a coefficient of thermal expansion of the insulating substrate 104 and the conductive base 106, between a coefficient of thermal expansion of the grid 101 and the insulating substrate 104. As a result, the posts 108 may distribute stress from thermal expansion to different surfaces. Dissimilar coefficients of thermal expansion between the insulating substrate 104 and other structures may have a reduced effect. Moreover, other materials that have a coefficient of thermal expansion that is further from that of the insulating substrate 104 may be used as the use of the posts 108 reduces the effect of the difference. In some embodiments, the material of the posts 108-1 and 108-2 may be different from a material of the posts 108-3 and 108-4. For example, if the materials of the conductive sides 102 are different from the material of the conductive base 106, different materials for the corresponding posts 108 may be selected to optimize any difference in a coefficient of thermal expansion.

In some embodiments, the posts 108 may include tubular structures. For example, the posts 108 may be open cylinders. Thermal expansion along the X direction or in the X-Z plane may be resisted radially by the posts 108. The posts 108 may deform radially, lessening the transfer of any stress from the expansion to the attachment locations. Moreover, the deformation may be at a location along the post 108 that is not part of the attachment to another structure, further isolating the effect of thermal expansion.

The increased resistance to mismatch between coefficients of thermal expansion may increase a yield of manufacturing the apparatus 100a. Later processing of the apparatus 100a, such as machining, may relieve stress at the junction between materials with dissimilar coefficients of thermal expansion. That stress relief may cause components to move such that at least some dimensions are out of an acceptable range. However, as the mismatch between coefficients of thermal expansion may be decreased, the movement due to the stress relief may be reduced, reducing a chance that the dimensions are out of the acceptable range and increasing the yield.

In some embodiments, the posts 108 may align the components with each other. For example, the posts 108-3 and 108-4 may align the insulating substrate 104 and the conductive base 106. In addition, the posts 108-3 and 108-4 or other posts 108 may align the apparatus 100a to any fixtures used in manufacturing the apparatus 100a.

In some embodiments, the posts 108 do not extend from the grid 101 through the insulating substrate 104 to the conductive base 106. The grid 101 and the conducive base 106 may be at different voltages during operation. Having different posts 108 to attach the insulating substrate 104 to the grid 101 than posts 108 to attach the insulating substrate 104 to the conductive base 106 may electrically isolate the grid 101 and the conductive base 106.

FIG. 2 is a block diagram of an apparatus with a field electron emitter according to some embodiments. The apparatus 100b may be similar to the apparatus 100a described above. However, the electron emitter 110′ may include a field emitter such as a Spindt emitter, a nanotube emitter, or the like. Although various electron emitters have been used as examples, in other embodiments, the electron emitter 110 may include different types of electron emitters.

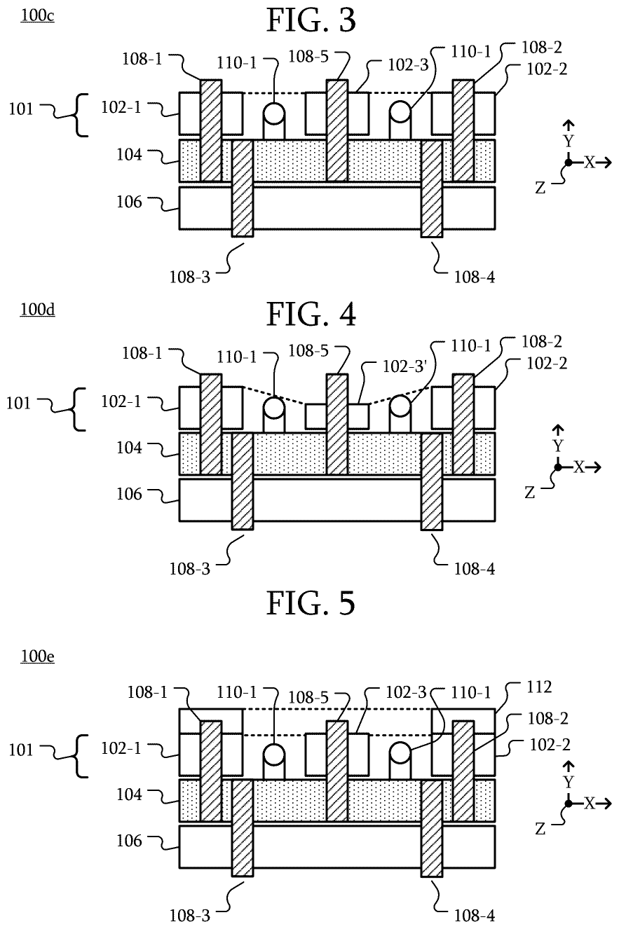

FIG. 3 is a block diagram of an apparatus with multiple electron emitters according to some embodiments. In some embodiments, an apparatus 100c may be similar to the apparatuses 100a or 100b. However, the apparatus 100c may include multiple grids 101 formed from multiple, separate conductive sides 102-1, 102-2, and 102-3. A first grid 101 includes conductive side 102-1 and 102-3. A second grid includes conductive side 102-2 and 102-3. While in this example, different grids 101 share a common conductive side 102-3, in other embodiments, different grids 101 may have independent conductive sides 102. Similar to the conductive sides 102-1 and 102-2 as described above, the conductive side 102-3 is attached to the insulating substrate 104 through an associated group of posts 108. Here, the group includes a single post 108-5; however, similar to the conductive sides 102-1 and 102-2, the group may include multiple posts 108.

The apparatus 100c includes multiple electron emitters 110. Here two electron emitters 110-1 and 110-2 Electron emitter 110-1 is disposed between conductive sides 102-1 and 102-3. Electron emitter 110-2 is disposed between conductive sides 102-2 and 102-3.

In some embodiments, the grids 101 are coplanar. The grids 101 are planar in the X-Z plane as illustrated by dashed lines between conductive sides 102-1 and 102-3 and between conductive sides 102-2 and 102-3. As the girds 101 are coplanar, a specialized fixture may not be needed during manufacturing to maintain an angle. For example, while machining the conductive sides 102-1 to 102-3, the operation may be substantially in the X-Z plane for both grids 101. Right angle fixturing with registerable datums may be used for inspection of various dimensions, such as a height of the electron emitters 110, in contrast to different angles or non-coplanar grids with more difficult registration.

In some embodiments, the apparatus 100c is used to superimpose electron beams from the electron emitters 110 on a target (not illustrated). Without more, the electron beams from the electron emitters 110 may be incident on different locations on the target. However, an electric field may be applied using voltages applied to the conductive sides 102 and the conductive base 106 to steer the electron beams so that the focal spots on the target overlap. In addition, different voltages may be used to modify a width of the focal spots. Further different voltages may be used to toggle one or both of the electron beams. In a particular embodiment, the voltages applied to the conductive sides 102-1 and 102-2 may be the same or similar while the voltage applied to the conductive side 102-3 may be different.

FIG. 4 is a block diagram of an apparatus with multiple electron emitters and non-coplanar grids according to some embodiments. In some embodiments, the apparatus 100d may be similar to the apparatus 100c. However, the apparatus 100d includes grids 101 that are not coplanar. For example, conductive side 102-3′ may be a different height in the Y direction than the conductive side 102-3. The dashed lines for a grid 101 including conductive sides 102-1 and 102-3′and a grid 101 including conductive sides 102-2 and 102-3′ show that the grids 101 are not coplanar.

FIG. 5 is a block diagram of an apparatus with multiple electron emitters according to some other embodiments. In some embodiments, the apparatus 100e may be similar to the apparatus 100c. However, the conductive sides 102-1 and 102-2 are electrically connected. Here, a conductive structure 112 is electrically connected to each of the conductive sides 102-1 and 102-2. The dashed lines represent an opening in the conductive structure to permit electron beams from the electron emitters 110 to pass through and to not make electrical contact with the conductive side 102-3.

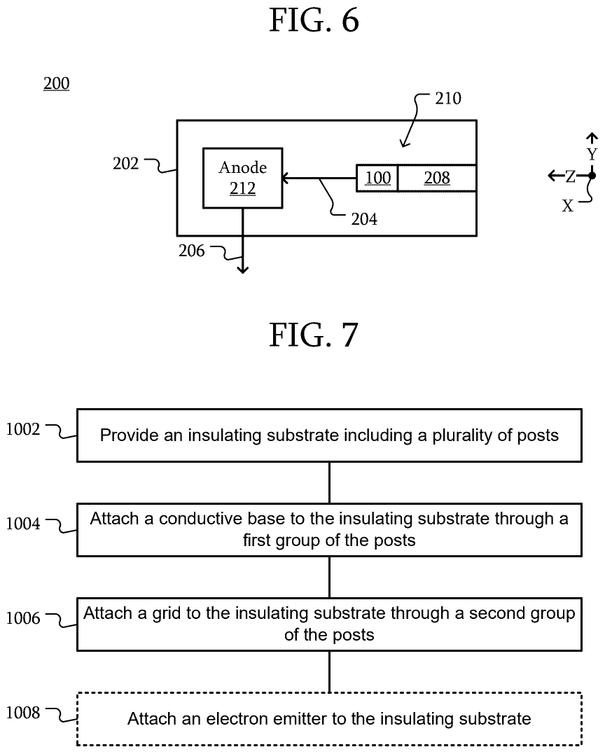

FIG. 6 is a block diagram of an x-ray source with an electron emitter according to some embodiments. In some embodiments, an x-ray source 200 includes a vacuum enclosure 202, a cathode 210, and an anode 212. The cathode 210 is configured to generate an electron beam 204. The cathode 210 includes an apparatus 100 as described above. The apparatus 100 may be supported within the vacuum enclosure 202 by a cathode support structure 208. The anode 212 includes a target configured to generate x-rays 206 in response to the electron beam 204.

FIG. 7 is a flowchart of a technique of forming an apparatus with an electron emitter according to some embodiments. The apparatus 100a will be used as an example. In 1002, an insulating substrate 104 including multiple posts 108 is provided. For example, the insulating substrate 104 including a variety of posts 108 attached to the insulating substrate 104 may be provided. In some embodiments, the posts 108 may be already attached to the insulating substrate 104 while in other embodiments, the posts 108 may be attached later.

In 1004, a conductive base 106 is attached to the insulating substrate 104 through a first group of the posts 108. For example, the posts 108-3 and 108-4 may be attached to the conductive base 106 and the insulating substrate 104. In 1006, a grid 101 is attached to the insulating substrate 104 through a second group of the posts 108. For example, the posts 108-1 and 108-2 may be attached to the grid 101 and the insulating substrate 104. The posts 108 may be attached to the corresponding structures through brazing, welding, or the like.

In some embodiments, the posts 108-1 to 108-4 are brazed to the insulating substrate 104. For example, the insulating substrate 104 may include metallization to form a contact location for the posts 108-1 to 108-4. The posts 108-1 to 108-4 may be brazed to the insulating substrate 104 at a first braze temperature. The conductive base 106 and the grid 101 may be placed over the corresponding posts 108. The apparatus 100 may be brazed at a second braze temperature that is less than the first braze temperature. In other embodiments, the sequence may be different. For example, some of the posts 108 may be brazed to the conductive base 106 while other posts 108 are brazed to the grid 101. The apparatus 100a may be assembled and the interface between the posts 108 and the insulating substrate 104 may be brazed. As a result, the conductive base 106 is attached to the insulating substrate 104 through a first group of the posts 108 by brazing the conductive base 106 to the first group of posts 108 and brazing the insulating substrate 104 to the first group of posts 108. The grid 101 is attached to the insulating substrate 104 through a second group of the posts 108 by brazing the grid 101 to the second group of posts 108 and brazing the insulating substrate 104 to the second group of posts 108.

In 1008, an electron emitter 110 is attached to the insulating substrate 104. In some embodiments, the electron emitter 110 is attached to the insulating substrate 104 before the insulating substrate 104 is attached to the conductive base 106 and/or grid 101. In some embodiments, the electron emitter 110 is attached to a different insulating substrate and then attached to the conductive base 106.

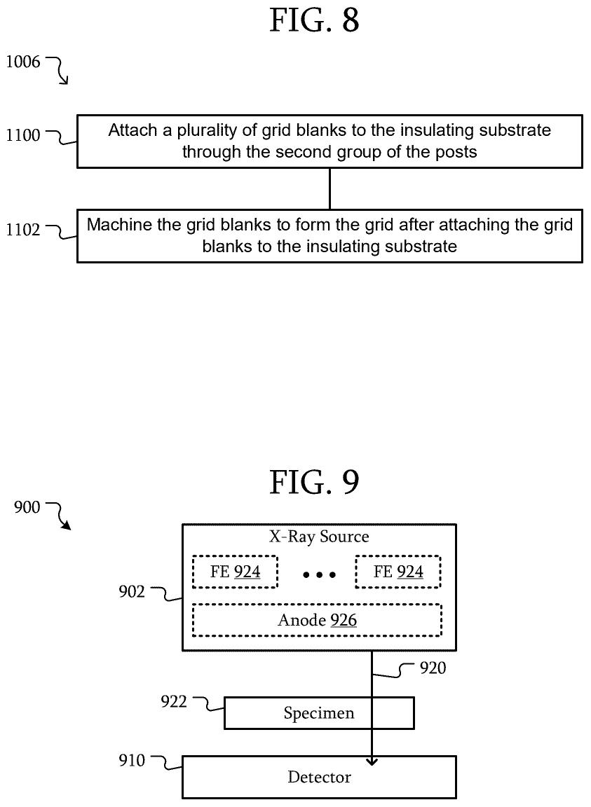

FIG. 8 is a flowchart of a technique of attaching a grid to an apparatus with an electron emitter according to some embodiments. Referring to FIGS. 7 and 8, in some embodiments, attaching the grid 101 to the insulating substrate 104 in 1006 includes attaching a plurality of grid blanks to the insulating substrate through the second group of the posts in 1100; and machining the grid blanks to form the grid after attaching the grid blanks to the insulating substrate in 1102. For example, grid blanks may be roughly in the shape of the conductive sides 102. The grid blanks are attached in 1100 and machined in 1102 into the shape of the corresponding conductive sides.

In some embodiments, each conductive side 102 may be associated with an individual grid blank. However, in other embodiments, a single grid blank may be machined to create two or more conductive sides 102.

In some embodiments, the machining of the grid blanks in 1102 occurs after the attachment in 1100. Once the grid blanks are attached, such as through brazing to the posts 108, the grid blanks may be machined. As a result, a desired tolerance may be achieved for a dimension associated with the grid 101, such as the grid width, separation from the electron emitter 110, or the like. In some embodiments, the grid blanks may be machined in 1102 to create coplanar grids. If the grid blanks were machined before attachment in 1100, the tolerance may be based on the tolerance of the attachment technique. While this may be undesirable in some embodiments, in other embodiments, the tolerance may be acceptable and the machining in 1102 may be performed before the attachment in 1100.

In some embodiments, attaching the grid 101 to the insulating substrate 104 in 1006 is part of attaching a plurality of grids 101 to the insulating substrate. For example, multiple grid blanks may be attached to the insulating substrate 104 through the posts 108 in 1100. Those grid blanks may be machined to create the multiple grids 101 in 1102.

FIG. 9 is a block diagram of an x-ray imaging system according to some embodiments. The x-ray imaging system 900 includes an x-ray source 902 and detector 910. The x-ray source 902 may include an x-ray source 200, including apparatuses 100, 100a-e, or the like as described above. In some embodiments, the x-ray source 902 includes multiple field emitters (FE) 924. Electron beams from the field emitters 924 may be directed towards an anode 926 to generate x-rays 920. The x-ray source 902 is disposed relative to the detector 910 such that x-rays 920 may be generated to pass through a specimen 922 and detected by the detector 910. In some embodiments, the detector 910 is part of a medical imaging system. In other embodiments, the x-ray imaging system 900 may include a portable vehicle scanning system as part of a cargo scanning system. The system 900 may be any system that may include an x-ray source and x-ray detector.

Embodiments include an apparatus 100, 100a-e, comprising: a conductive base 106; an insulating substrate 104; an electron emitter 110, 110-1, 110-2, 110′ disposed on the insulating substrate 104; a grid 101 disposed adjacent to the electron emitter 110, 110-1, 110-2, 110′, the grid 101 including a first conductive side 102-1 and a second conductive side 102-2 separate from the first conductive side 102-1; a plurality of posts 108; wherein: the first conductive side 102-1 is attached to the insulating substrate 104 through a first group of the posts 108; the second conductive side 102-2 is attached to the insulating substrate 104 through a second group of the posts 108; and the conductive base 106 is attached to the insulating substrate 104 through a third group of the posts 108.

In some embodiments, the electron emitter 110, 110-1, 110-2, 110′ is one of a plurality of electron emitters 110, 110-1, 110-2, 110′; the grid 101 is a first grid 101 of a plurality of grids 101; a second grid 101 of the plurality of grids 101 comprises the second conductive side 102-2 and a third conductive side 102-3 separate from the first conductive side 102-1 and the second conductive side 102-2; the third conductive side 102-3 is attached to the insulating substrate 104 through a fourth group of the posts 108; a first electron emitter 110, 110-1, 110-2, 110′ of the electron emitter 110, 110-1, 110-2, 110′s is disposed between the first conductive side 102-1 and the second conductive side 102-2; and a second electron emitter 110, 110-1, 110-2, 110′ of the electron emitter 110, 110-1, 110-2, 110's is disposed between the second conductive side 102-2 and the third conductive side.

In some embodiments, the first grid 101 and the second grid 101 are coplanar.

In some embodiments, the first conductive side 102-1 and the third conductive side 102-3 are electrically connected.

In some embodiments, the electron emitter 110, 110-1, 110-2, 110′ includes a thermionic emitter, a filament, or a field emitter.

In some embodiments, at least one of the posts 108 has a coefficient of thermal expansion that is between a coefficient of thermal expansion of the insulating substrate 104 and a coefficient of thermal expansion of the conductive base 106.

In some embodiments, at least one of the posts 108 has a coefficient of thermal expansion that is between a coefficient of thermal expansion of the grid 101 and a coefficient of thermal expansion of the insulating substrate 104.

In some embodiments, the conductive base 106 includes a first metal; the insulating substrate 104 includes a ceramic; and the grid 101 includes a second metal.

In some embodiments, the first conductive side 102-1 and the insulating substrate 104 are brazed to the first group of the posts 108; the second conductive side 102-2 and the insulating substrate 104 are brazed to the second group of the posts 108; and the conductive base 106 and the insulating substrate 104 are brazed to the third group of the posts 108.

Embodiments include an x-ray source, comprising: a cathode configured to generate an electron beam, including an apparatus 100, 100a-e as described above; and an anode 212 including a target configured to generate x-rays in response to the electron beam.

Embodiments include an apparatus 100, 100a-e, comprising: an insulating substrate 104; a first grid 101 and a second grid 101, the first grid 101 including a first conductive side 102-1 and a second conductive side 102-2 and the second grid 101 including the second conductive side 102-2 and a third conductive side 102-3; a first electron emitter 110, 110-1, 110-2, 110′ disposed adjacent to the first grid 101; and a second electron emitter 110, 110-1, 110-2, 110′ disposed adjacent to the second grid 101; wherein: the first conductive side 102-1, the second conductive side 102-2, and the third conductive side 102-3 are coplanar.

In some embodiments, the first conductive side 102-1 and the third conductive side 102-3 are electrically connected.

Embodiments include a method, comprising: providing an insulating substrate 104 including a plurality of posts 108; attaching a conductive base 106 to the insulating substrate 104 through a first group of the posts 108; and attaching a grid 101 to the insulating substrate 104 through a second group of the posts 108.

In some embodiments, the method further comprises attaching an electron emitter 110, 110-1, 110-2, 110′ to the insulating substrate 104.

In some embodiments, attaching the grid 101 to the insulating substrate 104 comprises: attaching a plurality of grid 101 blanks to the insulating substrate 104 through the second group of the posts 108; and machining the grid blanks to form the grid 101 after attaching the grid blanks to the insulating substrate 104.

In some embodiments, attaching the grid 101 to the insulating substrate 104 is part of attaching a plurality of grids 101 to the insulating substrate 104.

In some embodiments, attaching the grids 101 to the insulating substrate 104 comprises: attaching a plurality of grid 101 blanks to the insulating substrate 104 through the second group of the posts 108; and machining the grid blanks to form the grids 101 after attaching the grid blanks to the insulating substrate 104.

In some embodiments, machining the grid 101 blanks to form the grids 101 comprises: machining the grid blanks to form coplanar grids 101.

In some embodiments, attaching the conductive base 106 to the insulating substrate 104 through the first group of the posts 108 comprises brazing the conductive base 106 to the first group of posts 108 and brazing the insulating substrate 104 to the first group of posts 108; and attaching the grid 101 to the insulating substrate 104 through the second group of the posts 108 comprises brazing the grid 101 to the second group of posts 108 and brazing the insulating substrate 104 to the second group of posts 108.

In some embodiments, brazing the conductive base 106 to the first group of posts 108 is performed after brazing the grid 101 to the second group of posts 108.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claim 1, 3, or 4, with these separate dependencies yielding three distinct embodiments; claim 6 can depend from any one of claim 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

### DESCRIPTION OF THE RELATED ART

Some X-ray systems may include gridded cathode heads. Manufacturing of gridded cathode heads that require insulation between the grid components and the base material may have lower yields as compared with non-gridded cathode heads. Movement of the grid components relative to the base material during manufacturing may cause a failure.

### BRIEF DESCRIPTION OF DRAWINGS

FIGS. 1A-1B are block diagrams of an apparatus with an electron emitter according to some embodiments.

FIG. 2 is a block diagram of an apparatus with a field electron emitter according to some embodiments.

FIG. 3 is a block diagram of an apparatus with multiple electron emitters according to some embodiments.

FIG. 4 is a block diagram of an apparatus with multiple electron emitters and non-coplanar grids according to some embodiments.

FIG. 5 is a block diagram of an apparatus with multiple electron emitters according to some other embodiments.

FIG. 6 is a block diagram of an x-ray source with an electron emitter according to some embodiments.

FIG. 7 is a flowchart of a technique of forming an apparatus with an electron emitter according to some embodiments.

FIG. 8 is a flowchart of a technique of attaching a grid to an apparatus with an electron emitter according to some embodiments.

FIG. 9 is a block diagram of an x-ray imaging system according to some embodiments.

### DETAILED DESCRIPTION

Some embodiments include gridded cathode apparatuses, x-ray sources with gridded cathode apparatuses, and x-ray systems including the same. As will be described in further detail below, embodiments include apparatuses with electron emitters with various structures that may improve the yield. Such apparatuses may be installed in a cathode apparatus, x-ray source, x-ray system, or the like.

FIGS. 1A-1B are block diagrams of an apparatus with an electron emitter according to some embodiments. Referring to FIGS. 1A-1B, FIG. 1A is a cross-sectional view in plane 1A of FIG. 1B. In some embodiments, an apparatus 100a includes a conductive base 106, an insulating substrate 104, an electron emitter 110, multiple posts 108, and a grid 101.

The conductive base 106 may include a conductive material such as metal, steel, nickel, conductive alloys such as Kovar, or other conductive vacuum compatible materials. The insulating substrate 104 may include an insulating material such as ceramic such as alumina oxide ceramic, glass, or other vacuum compatible insulators.

The electron emitter 110 is disposed on the insulating substrate 104. The electron emitter 110 may be disposed on the insulating substrate 104 through isolating eyelets (not illustrated) or the like to create an electrical connection to terminals of the electron emitter 110 through the insulating substrate 104, the conductive base 106, or the like. In some embodiments, the eyelets pass through the insulating substrate 104 and are not directly attached to the insulating substrate 104. The eyelets may be isolated from the conductive base 106 by insulators separate from the insulating substrate; however, in other embodiments, one or more of the eyelets may be electrically connected to the conductive base 106. The electron emitter 110 is a device configured to generate electrons. For example, the electron emitter 110 may include a filament emitter, a thermionic emitter, a field emission emitter, or the like.

The grid 101 is disposed adjacent to the electron emitter 110. The grid 101 may include a conductive material such as metal, steel, nickel, conductive alloys such as Kovar, or other conductive vacuum compatible materials. The material of the grid 101 may be the same or different from the material of the conductive base 106.

One or more voltages may be applied to the grid 101, sub-parts of the grid 101, or the like. The applied voltage may, in combination with the electrical potential of the conductive base 106 may be configured to focus, steer, shape, or otherwise modify an electron beam generated from the electron emitter 110. In this example, the grid 101 includes a first conductive side 102-1 and a second conductive side 102-2 separate from the first conductive side 102-1. In some embodiments, the conductive sides 102-1 and 102-2 may be structurally separate, but electrically connected through another structure (not illustrated). In other embodiments, the conductive sides 102-1 and 102-2 may be electrically isolated from each other.

The posts 108 are attached to various other structures of the apparatus 100a. The posts 108 are attached to the corresponding structures along the length of the posts 108. The number of posts 108 attached to various structures of the apparatus 100a are used as examples. Other embodiments may include a different number of posts 108. The location of the attachment of the posts to the various structures are also an example. In other embodiments, the posts 108 may be attached to the various structures in different locations. For example, each of the conductive sides 102-1 and 102-2 may be attached with multiple posts 108 in a line along the Y direction.

The first conductive side 102-1 is attached to the insulating substrate 104 through a first group of the posts 108. Here, the first group includes a single post 108-1; however, in other embodiments, multiple posts 108 may be part of the first group that attaches the first conductive side 102-1 to the insulating substrate 104. Each of the first conductive side 102-1 and the insulating substrate 104 includes an opening in which the post 108-1 is disposed. The post 108-1 is attached to the first conductive side 102-1 and the insulating substrate 104.

The post 108-1 may be attached to the first conductive side 102-1 and the insulating substrate 104 by a variety of techniques. For example, the post 108-1 may be attached by brazing, welding, or the like. The structures may have additional components related to the attachment, such as metallization on the insulating substrate 104 that facilitates brazing to the post 108-1.

The first conductive side 102-1 and the insulating substrate 104 may not be attached directly together. Rather, the first conductive side 102-1 and the insulating substrate 104 may be attached through the post 108-1. Gaps are illustrated between the conductive sides 102-1, 102-2, insulating substrate 104, and the conductive base 106. The gaps are illustrated to show that the conductive sides 102-1, 102-2, insulating substrate 104, and the conductive base 106 are not attached directly to each other. Rather, the attachment between the components is through the posts 108. The components may contact each other, but may not be directly attached. As a result, a difference in thermal expansion between the conductive side 102-1 and the insulating substrate 104 may not result in the failure of an attachment location as the conductive side 102-1 and the insulating substrate 104 are not directly attached to each other.

In some embodiments, the post 108-1 only attaches to the first conductive side 102-1 and the insulating substrate 104. The post 108-1 may be separate from other structures. That is, the post 108-1 may not be attached to the conductive base 106. The post 108-1 may not contact the conductive base 106.

The second conductive side 108-2 is attached to the insulating substrate 104 through a second group of the posts 108. Here, the second group of the posts 108 includes a single post 108-2. The relationship, attachment, and the like of the post 108-2 to the second conductive side 108-2 and the insulating substrate 104 may be the same or similar to the attachments involving the post 108-1 described above.

The conductive base 106 is attached to the insulating substrate 104 through a third group of the posts 108. Here, the third group includes posts 108-3 and 108-4. However, in other embodiments, the third group may include one or more posts 108. The posts 108-3 and 108-4 may be attached to the conductive base 106 and the insulating substrate 104 in a manner the same or similar to the attachments involving the post 108-1 described above.

The material of the posts 108 may be selected based on materials of the conducive base 106, the insulating substrate 104, and the grid 101. For example, the material of the posts 108 may be selected to have a coefficient of thermal expansion that is between a coefficient of thermal expansion of the insulating substrate 104 and the conductive base 106, between a coefficient of thermal expansion of the grid 101 and the insulating substrate 104. As a result, the posts 108 may distribute stress from thermal expansion to different surfaces. Dissimilar coefficients of thermal expansion between the insulating substrate 104 and other structures may have a reduced effect. Moreover, other materials that have a coefficient of thermal expansion that is further from that of the insulating substrate 104 may be used as the use of the posts 108 reduces the effect of the difference. In some embodiments, the material of the posts 108-1 and 108-2 may be different from a material of the posts 108-3 and 108-4. For example, if the materials of the conductive sides 102 are different from the material of the conductive base 106, different materials for the corresponding posts 108 may be selected to optimize any difference in a coefficient of thermal expansion.

In some embodiments, the posts 108 may include tubular structures. For example, the posts 108 may be open cylinders. Thermal expansion along the X direction or in the X-Z plane may be resisted radially by the posts 108. The posts 108 may deform radially, lessening the transfer of any stress from the expansion to the attachment locations. Moreover, the deformation may be at a location along the post 108 that is not part of the attachment to another structure, further isolating the effect of thermal expansion.

The increased resistance to mismatch between coefficients of thermal expansion may increase a yield of manufacturing the apparatus 100a. Later processing of the apparatus 100a, such as machining, may relieve stress at the junction between materials with dissimilar coefficients of thermal expansion. That stress relief may cause components to move such that at least some dimensions are out of an acceptable range. However, as the mismatch between coefficients of thermal expansion may be decreased, the movement due to the stress relief may be reduced, reducing a chance that the dimensions are out of the acceptable range and increasing the yield.

In some embodiments, the posts 108 may align the components with each other. For example, the posts 108-3 and 108-4 may align the insulating substrate 104 and the conductive base 106. In addition, the posts 108-3 and 108-4 or other posts 108 may align the apparatus 100a to any fixtures used in manufacturing the apparatus 100a.

In some embodiments, the posts 108 do not extend from the grid 101 through the insulating substrate 104 to the conductive base 106. The grid 101 and the conducive base 106 may be at different voltages during operation. Having different posts 108 to attach the insulating substrate 104 to the grid 101 than posts 108 to attach the insulating substrate 104 to the conductive base 106 may electrically isolate the grid 101 and the conductive base 106.

FIG. 2 is a block diagram of an apparatus with a field electron emitter according to some embodiments. The apparatus 100b may be similar to the apparatus 100a described above. However, the electron emitter 110′ may include a field emitter such as a Spindt emitter, a nanotube emitter, or the like. Although various electron emitters have been used as examples, in other embodiments, the electron emitter 110 may include different types of electron emitters.

FIG. 3 is a block diagram of an apparatus with multiple electron emitters according to some embodiments. In some embodiments, an apparatus 100c may be similar to the apparatuses 100a or 100b. However, the apparatus 100c may include multiple grids 101 formed from multiple, separate conductive sides 102-1, 102-2, and 102-3. A first grid 101 includes conductive side 102-1 and 102-3. A second grid includes conductive side 102-2 and 102-3. While in this example, different grids 101 share a common conductive side 102-3, in other embodiments, different grids 101 may have independent conductive sides 102. Similar to the conductive sides 102-1 and 102-2 as described above, the conductive side 102-3 is attached to the insulating substrate 104 through an associated group of posts 108. Here, the group includes a single post 108-5; however, similar to the conductive sides 102-1 and 102-2, the group may include multiple posts 108.

The apparatus 100c includes multiple electron emitters 110. Here two electron emitters 110-1 and 110-2 Electron emitter 110-1 is disposed between conductive sides 102-1 and 102-3. Electron emitter 110-2 is disposed between conductive sides 102-2 and 102-3.

In some embodiments, the grids 101 are coplanar. The grids 101 are planar in the X-Z plane as illustrated by dashed lines between conductive sides 102-1 and 102-3 and between conductive sides 102-2 and 102-3. As the girds 101 are coplanar, a specialized fixture may not be needed during manufacturing to maintain an angle. For example, while machining the conductive sides 102-1 to 102-3, the operation may be substantially in the X-Z plane for both grids 101. Right angle fixturing with registerable datums may be used for inspection of various dimensions, such as a height of the electron emitters 110, in contrast to different angles or non-coplanar grids with more difficult registration.

In some embodiments, the apparatus 100c is used to superimpose electron beams from the electron emitters 110 on a target (not illustrated). Without more, the electron beams from the electron emitters 110 may be incident on different locations on the target. However, an electric field may be applied using voltages applied to the conductive sides 102 and the conductive base 106 to steer the electron beams so that the focal spots on the target overlap. In addition, different voltages may be used to modify a width of the focal spots. Further different voltages may be used to toggle one or both of the electron beams. In a particular embodiment, the voltages applied to the conductive sides 102-1 and 102-2 may be the same or similar while the voltage applied to the conductive side 102-3 may be different.

FIG. 4 is a block diagram of an apparatus with multiple electron emitters and non-coplanar grids according to some embodiments. In some embodiments, the apparatus 100d may be similar to the apparatus 100c. However, the apparatus 100d includes grids 101 that are not coplanar. For example, conductive side 102-3′ may be a different height in the Y direction than the conductive side 102-3. The dashed lines for a grid 101 including conductive sides 102-1 and 102-3′and a grid 101 including conductive sides 102-2 and 102-3′ show that the grids 101 are not coplanar.

FIG. 5 is a block diagram of an apparatus with multiple electron emitters according to some other embodiments. In some embodiments, the apparatus 100e may be similar to the apparatus 100c. However, the conductive sides 102-1 and 102-2 are electrically connected. Here, a conductive structure 112 is electrically connected to each of the conductive sides 102-1 and 102-2. The dashed lines represent an opening in the conductive structure to permit electron beams from the electron emitters 110 to pass through and to not make electrical contact with the conductive side 102-3.

FIG. 6 is a block diagram of an x-ray source with an electron emitter according to some embodiments. In some embodiments, an x-ray source 200 includes a vacuum enclosure 202, a cathode 210, and an anode 212. The cathode 210 is configured to generate an electron beam 204. The cathode 210 includes an apparatus 100 as described above. The apparatus 100 may be supported within the vacuum enclosure 202 by a cathode support structure 208. The anode 212 includes a target configured to generate x-rays 206 in response to the electron beam 204.

FIG. 7 is a flowchart of a technique of forming an apparatus with an electron emitter according to some embodiments. The apparatus 100a will be used as an example. In 1002, an insulating substrate 104 including multiple posts 108 is provided. For example, the insulating substrate 104 including a variety of posts 108 attached to the insulating substrate 104 may be provided. In some embodiments, the posts 108 may be already attached to the insulating substrate 104 while in other embodiments, the posts 108 may be attached later.

In 1004, a conductive base 106 is attached to the insulating substrate 104 through a first group of the posts 108. For example, the posts 108-3 and 108-4 may be attached to the conductive base 106 and the insulating substrate 104. In 1006, a grid 101 is attached to the insulating substrate 104 through a second group of the posts 108. For example, the posts 108-1 and 108-2 may be attached to the grid 101 and the insulating substrate 104. The posts 108 may be attached to the corresponding structures through brazing, welding, or the like.

In some embodiments, the posts 108-1 to 108-4 are brazed to the insulating substrate 104. For example, the insulating substrate 104 may include metallization to form a contact location for the posts 108-1 to 108-4. The posts 108-1 to 108-4 may be brazed to the insulating substrate 104 at a first braze temperature. The conductive base 106 and the grid 101 may be placed over the corresponding posts 108. The apparatus 100 may be brazed at a second braze temperature that is less than the first braze temperature. In other embodiments, the sequence may be different. For example, some of the posts 108 may be brazed to the conductive base 106 while other posts 108 are brazed to the grid 101. The apparatus 100a may be assembled and the interface between the posts 108 and the insulating substrate 104 may be brazed. As a result, the conductive base 106 is attached to the insulating substrate 104 through a first group of the posts 108 by brazing the conductive base 106 to the first group of posts 108 and brazing the insulating substrate 104 to the first group of posts 108. The grid 101 is attached to the insulating substrate 104 through a second group of the posts 108 by brazing the grid 101 to the second group of posts 108 and brazing the insulating substrate 104 to the second group of posts 108.

In 1008, an electron emitter 110 is attached to the insulating substrate 104. In some embodiments, the electron emitter 110 is attached to the insulating substrate 104 before the insulating substrate 104 is attached to the conductive base 106 and/or grid 101. In some embodiments, the electron emitter 110 is attached to a different insulating substrate and then attached to the conductive base 106.

FIG. 8 is a flowchart of a technique of attaching a grid to an apparatus with an electron emitter according to some embodiments. Referring to FIGS. 7 and 8, in some embodiments, attaching the grid 101 to the insulating substrate 104 in 1006 includes attaching a plurality of grid blanks to the insulating substrate through the second group of the posts in 1100; and machining the grid blanks to form the grid after attaching the grid blanks to the insulating substrate in 1102. For example, grid blanks may be roughly in the shape of the conductive sides 102. The grid blanks are attached in 1100 and machined in 1102 into the shape of the corresponding conductive sides.

In some embodiments, each conductive side 102 may be associated with an individual grid blank. However, in other embodiments, a single grid blank may be machined to create two or more conductive sides 102.

In some embodiments, the machining of the grid blanks in 1102 occurs after the attachment in 1100. Once the grid blanks are attached, such as through brazing to the posts 108, the grid blanks may be machined. As a result, a desired tolerance may be achieved for a dimension associated with the grid 101, such as the grid width, separation from the electron emitter 110, or the like. In some embodiments, the grid blanks may be machined in 1102 to create coplanar grids. If the grid blanks were machined before attachment in 1100, the tolerance may be based on the tolerance of the attachment technique. While this may be undesirable in some embodiments, in other embodiments, the tolerance may be acceptable and the machining in 1102 may be performed before the attachment in 1100.

In some embodiments, attaching the grid 101 to the insulating substrate 104 in 1006 is part of attaching a plurality of grids 101 to the insulating substrate. For example, multiple grid blanks may be attached to the insulating substrate 104 through the posts 108 in 1100. Those grid blanks may be machined to create the multiple grids 101 in 1102.

FIG. 9 is a block diagram of an x-ray imaging system according to some embodiments. The x-ray imaging system 900 includes an x-ray source 902 and detector 910. The x-ray source 902 may include an x-ray source 200, including apparatuses 100, 100a-e, or the like as described above. In some embodiments, the x-ray source 902 includes multiple field emitters (FE) 924. Electron beams from the field emitters 924 may be directed towards an anode 926 to generate x-rays 920. The x-ray source 902 is disposed relative to the detector 910 such that x-rays 920 may be generated to pass through a specimen 922 and detected by the detector 910. In some embodiments, the detector 910 is part of a medical imaging system. In other embodiments, the x-ray imaging system 900 may include a portable vehicle scanning system as part of a cargo scanning system. The system 900 may be any system that may include an x-ray source and x-ray detector.

Embodiments include an apparatus 100, 100a-e, comprising: a conductive base 106; an insulating substrate 104; an electron emitter 110, 110-1, 110-2, 110′ disposed on the insulating substrate 104; a grid 101 disposed adjacent to the electron emitter 110, 110-1, 110-2, 110′, the grid 101 including a first conductive side 102-1 and a second conductive side 102-2 separate from the first conductive side 102-1; a plurality of posts 108; wherein: the first conductive side 102-1 is attached to the insulating substrate 104 through a first group of the posts 108; the second conductive side 102-2 is attached to the insulating substrate 104 through a second group of the posts 108; and the conductive base 106 is attached to the insulating substrate 104 through a third group of the posts 108.

In some embodiments, the electron emitter 110, 110-1, 110-2, 110′ is one of a plurality of electron emitters 110, 110-1, 110-2, 110′; the grid 101 is a first grid 101 of a plurality of grids 101; a second grid 101 of the plurality of grids 101 comprises the second conductive side 102-2 and a third conductive side 102-3 separate from the first conductive side 102-1 and the second conductive side 102-2; the third conductive side 102-3 is attached to the insulating substrate 104 through a fourth group of the posts 108; a first electron emitter 110, 110-1, 110-2, 110′ of the electron emitter 110, 110-1, 110-2, 110′s is disposed between the first conductive side 102-1 and the second conductive side 102-2; and a second electron emitter 110, 110-1, 110-2, 110′ of the electron emitter 110, 110-1, 110-2, 110′s is disposed between the second conductive side 102-2 and the third conductive side.

In some embodiments, the first grid 101 and the second grid 101 are coplanar.

In some embodiments, the first conductive side 102-1 and the third conductive side 102-3 are electrically connected.

In some embodiments, the electron emitter 110, 110-1, 110-2, 110′ includes a thermionic emitter, a filament, or a field emitter.

In some embodiments, at least one of the posts 108 has a coefficient of thermal expansion that is between a coefficient of thermal expansion of the insulating substrate 104 and a coefficient of thermal expansion of the conductive base 106.

In some embodiments, at least one of the posts 108 has a coefficient of thermal expansion that is between a coefficient of thermal expansion of the grid 101 and a coefficient of thermal expansion of the insulating substrate 104.

In some embodiments, the conductive base 106 includes a first metal; the insulating substrate 104 includes a ceramic; and the grid 101 includes a second metal.

In some embodiments, the first conductive side 102-1 and the insulating substrate 104 are brazed to the first group of the posts 108; the second conductive side 102-2 and the insulating substrate 104 are brazed to the second group of the posts 108; and the conductive base 106 and the insulating substrate 104 are brazed to the third group of the posts 108.

Embodiments include an x-ray source, comprising: a cathode configured to generate an electron beam, including an apparatus 100, 100a-e as described above; and an anode 212 including a target configured to generate x-rays in response to the electron beam.

Embodiments include an apparatus 100, 100a-e, comprising: an insulating substrate 104; a first grid 101 and a second grid 101, the first grid 101 including a first conductive side 102-1 and a second conductive side 102-2 and the second grid 101 including the second conductive side 102-2 and a third conductive side 102-3; a first electron emitter 110, 110-1, 110-2, 110′ disposed adjacent to the first grid 101; and a second electron emitter 110, 110-1, 110-2, 110′ disposed adjacent to the second grid 101; wherein: the first conductive side 102-1, the second conductive side 102-2, and the third conductive side 102-3 are coplanar.

In some embodiments, the first conductive side 102-1 and the third conductive side 102-3 are electrically connected.

Embodiments include a method, comprising: providing an insulating substrate 104 including a plurality of posts 108; attaching a conductive base 106 to the insulating substrate 104 through a first group of the posts 108; and attaching a grid 101 to the insulating substrate 104 through a second group of the posts 108.

In some embodiments, the method further comprises attaching an electron emitter 110, 110-1, 110-2, 110′ to the insulating substrate 104.

In some embodiments, attaching the grid 101 to the insulating substrate 104 comprises: attaching a plurality of grid 101 blanks to the insulating substrate 104 through the second group of the posts 108; and machining the grid blanks to form the grid 101 after attaching the grid blanks to the insulating substrate 104.

In some embodiments, attaching the grid 101 to the insulating substrate 104 is part of attaching a plurality of grids 101 to the insulating substrate 104.

In some embodiments, attaching the grids 101 to the insulating substrate 104 comprises: attaching a plurality of grid 101 blanks to the insulating substrate 104 through the second group of the posts 108; and machining the grid blanks to form the grids 101 after attaching the grid blanks to the insulating substrate 104.

In some embodiments, machining the grid 101 blanks to form the grids 101 comprises: machining the grid blanks to form coplanar grids 101.

In some embodiments, attaching the conductive base 106 to the insulating substrate 104 through the first group of the posts 108 comprises brazing the conductive base 106 to the first group of posts 108 and brazing the insulating substrate 104 to the first group of posts 108; and attaching the grid 101 to the insulating substrate 104 through the second group of the posts 108 comprises brazing the grid 101 to the second group of posts 108 and brazing the insulating substrate 104 to the second group of posts 108.

In some embodiments, brazing the conductive base 106 to the first group of posts 108 is performed after brazing the grid 101 to the second group of posts 108.

Although the structures, devices, methods, and systems have been described in accordance with particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the spirit and scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claim 1, 3, or 4, with these separate dependencies yielding three distinct embodiments; claim 6 can depend from any one of claim 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f). Embodiments of the invention in which an exclusive property or privilege is claimed are defined as follows.

1. An apparatus, comprising:
a conductive base;
an insulating substrate;
an electron emitter disposed on the insulating substrate;
a grid disposed adjacent to the electron emitter, the grid including a first conductive side and a second conductive side separate from the first conductive side;
a plurality of posts;
wherein:
the first conductive side is attached to the insulating substrate through a first group of the posts;
the second conductive side is attached to the insulating substrate through a second group of the posts; and
the conductive base is attached to the insulating substrate through a third group of the posts.

2. The apparatus of claim 1, wherein:
the electron emitter is one of a plurality of electron emitters;
the grid is a first grid of a plurality of grids;
a second grid of the plurality of grids comprises the second conductive side and a third conductive side separate from the first conductive side and the second conductive side;
the third conductive side is attached to the insulating substrate through a fourth group of the posts;
a first electron emitter of the electron emitters is disposed between the first conductive side and the second conductive side; and
a second electron emitter of the electron emitters is disposed between the second conductive side and the third conductive side.

3. The apparatus of claim 2, wherein:
the first grid and the second grid are coplanar.

4. The apparatus of claim 2, wherein:
the first conductive side and the third conductive side are electrically connected.

5. The apparatus of claim 1, wherein:
the electron emitter includes a thermionic emitter, a filament, or a field emitter.

6. The apparatus of claim 1, wherein:
at least one of the posts has a coefficient of thermal expansion that is between a coefficient of thermal expansion of the insulating substrate and a coefficient of thermal expansion of the conductive base.

7. The apparatus of claim 1, wherein:
at least one of the posts has a coefficient of thermal expansion that is between a coefficient of thermal expansion of the grid and a coefficient of thermal expansion of the insulating substrate.

8. The apparatus of claim 1, wherein:
the conductive base includes a first metal;
the insulating substrate includes a ceramic; and
the grid includes a second metal.

9. The apparatus of claim 1, wherein:
the first conductive side and the insulating substrate are brazed to the first group of the posts;
the second conductive side and the insulating substrate are brazed to the second group of the posts; and
the conductive base and the insulating substrate are brazed to the third group of the posts.

10. An x-ray source, comprising:
a cathode configured to generate an electron beam, including the apparatus of claim 1; and
an anode including a target configured to generate x-rays in response to the electron beam.

11. An apparatus, comprising:
an insulating substrate;
a first grid and a second grid, the first grid including a first conductive side and a second conductive side and the second grid including the second conductive side and a third conductive side;
a first electron emitter disposed adjacent to the first grid; and
a second electron emitter disposed adjacent to the second grid;
wherein:
the first conductive side, the second conductive side, and the third conductive side are coplanar.

12. The apparatus of claim 11, wherein:
the first conductive side and the third conductive side are electrically connected.

13. A method, comprising:
providing an insulating substrate including a plurality of posts;
attaching a conductive base to the insulating substrate through a first group of the posts; and
attaching a grid to the insulating substrate through a second group of the posts.

14. The method of claim 13, further comprising:
attaching an electron emitter to the insulating substrate.

15. The method of claim 13, wherein attaching the grid to the insulating substrate comprises:
attaching a plurality of grid blanks to the insulating substrate through the second group of the posts; and
machining the grid blanks to form the grid after attaching the grid blanks to the insulating substrate.

16. The method of claim 13, wherein:
attaching the grid to the insulating substrate is part of attaching a plurality of grids to the insulating substrate.

17. The method of claim 16, wherein attaching the grids to the insulating substrate comprises:
attaching a plurality of grid blanks to the insulating substrate through the second group of the posts; and
machining the grid blanks to form the grids after attaching the grid blanks to the insulating substrate.

18. The method of claim 17, wherein machining the grid blanks to form the grids comprises:
machining the grid blanks to form coplanar grids.

19. The method of claim 13, wherein:
attaching the conductive base to the insulating substrate through the first group of the posts comprises brazing the conductive base to the first group of posts and brazing the insulating substrate to the first group of posts; and
attaching the grid to the insulating substrate through the second group of the posts comprises brazing the grid to the second group of posts and brazing the insulating substrate to the second group of posts.

20. The method of claim 19, wherein:
brazing the conductive base to the first group of posts is performed after brazing the grid to the second group of posts.
